(19) United States
(12) Patent Application Publication
(10) Pub. No.: US 2022/0090934 A1
(43) Pub. Date: Mar. 24, 2022

(54) GUIDE GENERATION METHOD AND GUIDE SYSTEM

(71) Applicant: Faurecia Clarion Electronics Co., Ltd., Saitama-shi (JP)

(72) Inventors: Kenji TAKEUCHI, Saitama (JP); Masahiko SEKI, Saitama (JP); Miku NAGATSUKA, Saitama (JP)

(73) Assignee: Faurecia Clarion Electronics Co., Ltd., Saitama-shi (JP)

(21) Appl. No.: 17/479,652

(22) Filed: Sep. 20, 2021

(30) Foreign Application Priority Data
Sep. 23, 2020 (JP) 2020-159027

(51) Int. Cl. G01C 21/36; G08G 1/017

(52) U.S. Cl. CPC G01C 21/3629; G08G 1/017

(57) ABSTRACT

A guide generation method performed by a computer includes: a vehicle information acquisition step of acquiring vehicle information including a current position and an appearance feature of a vehicle; a guide point determination step of determining a guide point located on a scheduled traveling route of the vehicle, based on the vehicle information and map information; a mark vehicle determination step of determining a mark vehicle, among vehicles traveling around a target vehicle, from one or more candidate vehicles that make a turn at the same guide point in the same direction as the guide point and a direction of the target vehicle; and a guide information generation step of generating guide information that includes the appearance feature of the mark vehicle and a positional relationship between the target vehicle and the mark vehicle, and that guides a turn at the guide point with the mark vehicle as a marker.

### BACKGROUND

The present invention relates to a guide generation method and a guide system.

JP 2012-112848 A (PTL 1) relates to a navigation device, and describes that “when a vehicle position approaches a specific point where a sound guide is provided on a guide route within a predetermined distance, a screen for displaying a map is divided and an enlarged map around the specific point and a local road map are displayed. Icons of a standard set facility being previously set and a user set facility being set by a user other than the standard set facility are displayed on the maps. At this time, when the neighboring set facility is present within the predetermined distance before the specific point, a sound guide including a name of the user set facility is provided prior to the standard set facility”.

PTL 1: JP 2012-112848 A

### SUMMARY

When the navigation device in JP 2012-112848 A displays a specific point enlarged diagram such as an intersection enlarged diagram at a specific point such as a right/left turn intersection, the navigation device displays as facility icon preferred by a user, and also provides a sound guide of a right/left turn and the like with the facility as a marker. However, it is actually difficult to visually recognize, from a distance, a facility as a marker while traveling in front of an intersection, and a case where the facility blocked by another vehicle cannot be confirmed and the like also occur. Thus, it is desirable to indicate a marker that is more intuitively clear for a user at a branch point such as an intersection to provide a guide.

Thus, an object of the present invention is to indicate a marker that is more intuitively clear to guide a user.

The present application includes a plurality of solutions to at least a part of the above-mentioned problem. One example of the solutions is as follows. A guide generation method according to one aspect of the present invention that solves the above-mentioned problem is a guide generation method performed by a computer, the computer performing: a vehicle information acquisition step of acquiring vehicle information including a current position and an appearance feature of a vehicle; a guide point determination step of determining a guide point located on a scheduled traveling route of the vehicle, based on the vehicle information and map information; a mark vehicle determination step of determining a mark vehicle, among vehicles traveling around a target vehicle, from one or more candidate vehicles that make a turn at the same guide point in the same direction as the guide point and a direction of the target vehicle; and a guide information generation step of generating guide information that includes the appearance feature of the mark vehicle and a positional relationship between the target vehicle and the mark vehicle, and that guides a turn at the guide point with the mark vehicle as a marker.

The present invention can indicate a marker that is more intuitively clear to guide a user.

Note that a problem, configuration, and effect other than those described in the above will be apparent from the description of embodiments given below.

### BRIEF DESCRIPTION OF DRAWINGS

FIG. 1 is a diagram illustrating an example of a schematic configuration of a guide system.

FIG. 2 is a diagram illustrating an example of a hardware configuration of a guide information generation device.

FIG. 3 is a diagram illustrating an example of a hardware configuration of a guide output device.

FIG. 4 is a flowchart illustrating an example of guide information generation processing.

FIGS. 5A and 5B are each a diagram illustrating a positional relationship among a target vehicle, a candidate vehicle, and a non-candidate vehicle.

FIGS. 6A and 6B are each a diagram illustrating a scene where a guide is provided.

### DESCRIPTION OF EMBODIMENTS

An embodiment of the present invention will be described below.

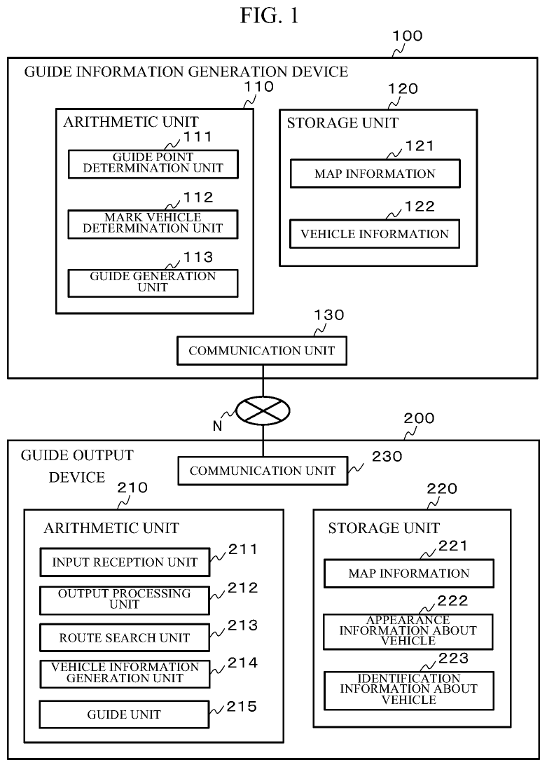

FIG. 1 is a diagram illustrating an example of a schematic configuration of a guide system according to the present embodiment. As illustrated, the guide system includes a guide information generation device 100 and a guide output device 200. These devices are communicably connected to each other via a predetermined network N such as a public network, such as the Internet, a local area network (LAN), or a wide area network (WAN).

The guide information generation device 100 is a device that generates guide information for guiding a driver (user) who drives a vehicle. Specifically, the guide information generation device 100 periodically acquires, from the guide output device 200, vehicle information including route information indicating a scheduled traveling route of a vehicle, positional information indicating a current position of the vehicle, and appearance information indicating an appearance feature (for example, a car type, a body color, a type of a body shape, a license plate number, and the like) of the vehicle, and determines, by using the pieces of information, a vehicle (hereinafter may be referred to as a “mark vehicle”) serving as a marker when a right/left turn is made at a guide point on the scheduled traveling route.

The guide information generation device 100 generates the guide information that includes an appearance feature for a driver to identify the mark vehicle, and a positional relationship between a vehicle (hereinafter may be referred to as a “target vehicle”) driven by the driver and the mark vehicle, and guides a right/left turn at the guide point with the mark vehicle as a marker.

The guide output device 200 is a device that is installed on a vehicle and guides a driver by using the guide information. Specifically, the guide output device 200 periodically transmits, to the guide information generation device 100, the vehicle information including route information, the positional information, and the appearance information of the vehicle. The guide output device 200 acquires the guide information from the guide information generation device 100, and provides a guide at the guide point by using the guide information.

Hereinafter, an example of a functional configuration of the guide information generation device 100 and the guide output device 200 will be described.

As illustrated in FIG. 1, the guide information generation device 100 includes an arithmetic unit 110, a storage unit 120, and a communication unit 130.

The arithmetic unit 110 is a function unit that performs various types of processing performed in the guide information generation device 100. Specifically, the arithmetic unit 110 includes a guide point determination unit 111, a mark vehicle determination unit 112, and a guide generation unit 113.

The guide point determination unit 111 is a function unit that determines the guide point on the scheduled traveling route (on recommended route). Specifically, the guide point determination unit 111 determines, by using map information 121 and the route information included in vehicle information 122, the guide point being a branch point such as an intersection where the vehicle makes a right/left turn. The guide point determination unit 111 determines a direction (either a right turn or a left turn) in which the vehicle makes a turn at a determined guide point.

The mark vehicle determination unit 112 is a function unit that determines the mark vehicle serving as a marker of a guide at the guide point. Specifically, by using the guide point determined by the guide point determination unit 111 and the vehicle information 122 acquired from each vehicle, the mark vehicle determination unit 112 determines, as a candidate (hereinafter may be referred to as a “candidate vehicle”) for the mark vehicle, a vehicle that is scheduled to make a turn at a nearest guide point at which the target vehicle makes a turn in the same direction as the target vehicle and that is traveling in front of the target vehicle toward the guide point.

The mark vehicle determination unit 112 determines the mark vehicle among candidate vehicles according to a predetermined rule. Specifically, when a candidate vehicle is only one, the mark vehicle determination unit 112 determines the candidate vehicle as the mark vehicle. When there is a plurality of candidate vehicles, the mark vehicle determination unit 112 determines, as a mark vehicle, a candidate vehicle traveling in a position closest to the target vehicle. When a non-candidate vehicle that does not make a right/left turn at the guide point at which the target vehicle makes a turn or a non-candidate vehicle that makes a turn in a direction different from that of the target vehicle at the guide point at which the target vehicle makes a turn is located between the target vehicle and a candidate vehicle closest to the target vehicle, the mark vehicle determination unit 112 determines, as the mark vehicle, a candidate vehicle traveling in a position closest to the target vehicle among candidate vehicles traveling in a lane different from that of the target vehicle.

The mark vehicle determination unit 112 determines the appearance feature of the mark vehicle by using appearance information included in the vehicle information 122. The mark vehicle determination unit 112 determines a positional relationship between the target vehicle and the mark vehicle by using positional information about the target vehicle and the mark vehicle, and the map information 121. More specifically, the mark vehicle determination unit 112 determines the positional relationship between the target vehicle and the mark vehicle, based on a distance between the target vehicle and the mark vehicle, and a lane in which the target vehicle and the mark vehicle are traveling.

The guide generation unit 113 is a function unit that generates the guide information. Specifically, the guide generation unit 113 generates the guide information that includes the appearance feature of the mark vehicle, and the positional relationship between the target vehicle and the mark vehicle, and guides a right/left turn at the guide point with the mark vehicle as a marker.

The storage unit 120 is a function unit that stores various types of information. Specifically, the storage unit 120 stores the map information 121, and the vehicle information 122 acquired from each vehicle via the communication unit 130.

The map information 121 includes, for each predetermined region acquired by segmenting a map, link information that stores detailed information about a road in the predetermined region. The link information includes information related to a road, such as a start node and an end node of a road, a road type, a road name, a link length, movement time (travel time), a link characteristic (for example, an up-bound lane, a down-bound lane, and the like), a legally permitted speed of each link, and lane information for identifying a traveling lane, for example.

The communication unit 130 is a function unit that performs information communication with an external device (for example, the guide output device 200). Specifically, the communication unit 130 acquires the vehicle information 122 from the guide output device 200. The communication unit 130 transmits guide information to the guide output device 200.

An example of the functional configuration of the guide information generation device 100 is described above.

As illustrated in FIG. 1, the guide output device 200 includes an arithmetic unit 210, a storage unit 220, and a communication unit 230.

The arithmetic unit 210 is a function unit that performs various types of processing performed in the guide output device 200. Specifically, the arithmetic unit 210 includes an input reception unit 211, an output processing unit 212, a route search unit 213, a vehicle information generation unit 214, and a guide unit 215.

The input reception unit 211 is a function unit that receives an input of an instruction by a user and information via an input device included in the guide output device 200. Specifically, the input reception unit 211 receives an input of a departure place and a destination via the input device. The input reception unit 211 receives, from a user, a route search instruction of a recommended route connecting the departure place to the destination.

The output processing unit 212 is a function unit that outputs display information of a map and sound information via an output device (for example, a display device such as a display, a speaker that outputs a sound, and the like) included in the guide output device 200. Specifically, the output processing unit 212 outputs, to the display, the display information of a map on which a current position of a vehicle and the recommended route are superimposed. The output processing unit 212 outputs, to the speaker, music and sound information about the opposing person on a hands-free telephone, for example.

The route search unit 213 is a function unit that searches for a recommended route connecting the departure place to the destination. Specifically, by using the departure place and the destination that are received from a user, map information 221 stored in the storage unit 220, and road traffic information acquired via the communication unit 230, the route search unit 213 searches for (calculates) the recommended route connecting the departure place (or the current position) to the destination.

The vehicle information generation unit 214 is a function unit that generates the vehicle information 122 including the route information, positional information about the vehicle, and appearance information about the vehicle. Specifically, when the recommended route calculated by the route search unit 213 is set as a scheduled traveling route, the vehicle information generation unit 214 acquires the recommended route (scheduled traveling route) as the route information. The vehicle information generation unit 214 determines a current position of the vehicle on a map by using the map information 221 in the storage unit 220, and the positional information acquired via a GPS information reception device. The vehicle information generation unit 214 acquires, from the storage unit 220, a car type (such as a regular passenger car and a light four-wheeled passenger car), a body color (such as white, red, blue, and silver), a type of a body shape (for example, a sedan, a sport utility vehicle (SUV), a station wagon, a minivan, a truck, and the like), and a license plate number that are appearance information 222 about the vehicle being previously stored in the storage unit 220.

The vehicle information generation unit 214 generates the vehicle information 122 including the pieces of information described above and identification information 223 (for example, a vehicle ID and the like) about the vehicle being previously stored in the storage unit 220, and transmits the vehicle information 122 to the guide information generation device 100 via the communication unit 230 periodically (for example, every second).

The guide unit 215 is a function unit that provides a guide at a guide point. Specifically, the guide unit 215 outputs, to the display or the speaker of the vehicle, sound information or image information for guiding a right/left turn at the guide point with the mark vehicle as a marker by using the guide information.

The storage unit 220 is a function unit that stores various types of information. Specifically, the storage unit 220 stores the map information 221, the appearance information 222 about the vehicle, and the identification information 223 about the vehicle. Note that the map information 221 is information common to the map information 121 stored in the storage unit 120 of the guide information generation device 100.

The communication unit 230 is a function unit that performs information communication with an external device (for example, the guide information generation device 100). Specifically, the communication unit 230 transmits the vehicle information 122 to the guide information generation device 100. The communication unit 230 acquires guide information from the guide information generation device 100.

An example of the functional configuration of the guide output device 200 is described above.

Next, a hardware configuration of the guide information generation device 100 and the guide output device 200 will be described.

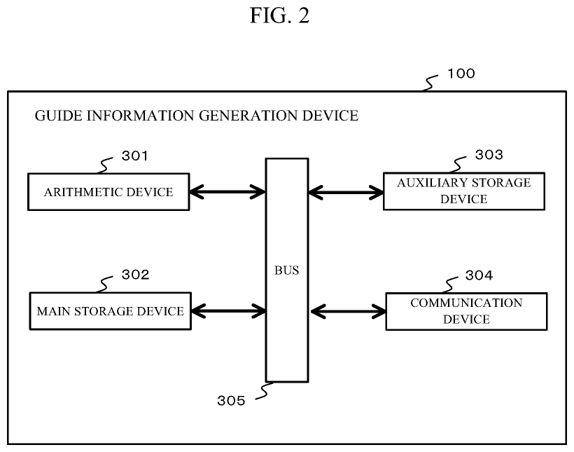

FIG. 2 is a diagram illustrating an example of the hardware configuration of the guide information generation device 100. The guide information generation device 100 is a high-performance information processing device such as a server, for example. As illustrated, the guide information generation device 100 includes an arithmetic device 301, a main storage device 302, an auxiliary storage device 303, a communication device 304, and a bus 305 that electrically connects the devices.

The arithmetic device 301 is an arithmetic processing device such as a central processing unit (CPU), for example. The main storage device 302 is a memory device such as a random access memory (RAM) that temporarily stores various types of read information and a read only memory (ROM) that stores a program executed by the CPU. The auxiliary storage device 303 is a non-volatile storage device such as a hard disk drive (HDD) that can store digital information, a solid state drive (SSD), or a flash memory. The communication device 304 is a communication module that performs information communication with an external device, and the like. The bus 305 is a communication line that communicably connects the devices each other.

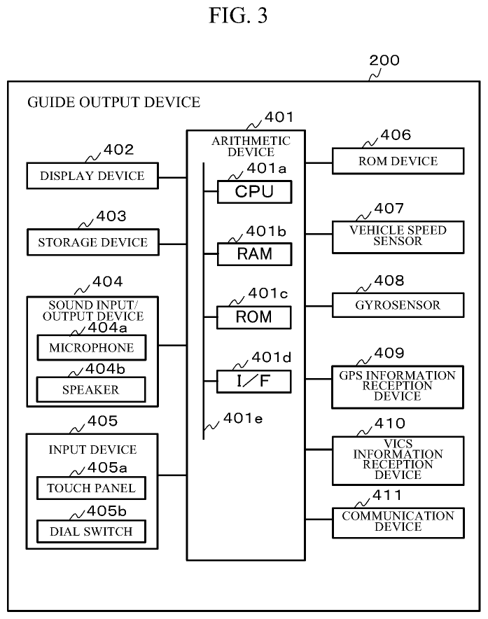

FIG. 3 is a diagram illustrating an example of the hardware configuration of the guide output device 200. The guide output device 200 is, for example, a navigation device having a navigation function or a display audio (DA). As illustrated, the guide output device 200 includes an arithmetic device 401, a display device (display) 402, a storage device 403, a sound input/output device 404, an input device 405, a ROM device 406, a vehicle speed sensor 407, a gyro sensor 408, a GPS information reception device 409, a VICS information reception device 410, and a communication device 411.

The arithmetic device 401 includes a CPU 401a that performs arithmetic processing, a RAM 401b that temporarily stores various types of information read from the storage device 403 or the ROM device 406, a ROM 401c that stores a program executed by the CPU 401a, and the like, an interface (I/F) 401d for connecting various types of hardware to the arithmetic device 401, and a bus 401e that connects the CPU 401a, the RAM 401b, the ROM 401c, and the I/F 401d to one another.

The display device 402 is a unit that displays graphics information, and is formed of, for example, a liquid crystal display, an organic EL display, and the like. The storage device 403 is a storage medium that can perform at least writing and reading, such as an HDD, an SSD, or a non-volatile memory card, and stores various types of information (for example, the map information 221 and the like).

The sound input/output device 404 includes a microphone 404a that collects voice emitted from a driver and a passenger, and a speaker 404b that outputs a sound guide to the driver and the like. Note that the speaker 404b may be an onboard speaker 404b mounted on a vehicle.

The input device 405 is a device that receives an instruction input from a user, such as a touch panel 405a and a dial switch 405b. The ROM device 406 is a storage medium that can perform at least writing and reading, such as a ROM such as a CD-ROM and a DVD-ROM, or an integrated circuit (IC) card, and stores video data, sound data, and the like, for example.

The vehicle speed sensor 407, the gyro sensor 408, and the GPS information reception device 409 are used for detecting a current position of a vehicle on which the guide output device 200 is mounted. The vehicle speed sensor 407 outputs information used for calculating a vehicle speed. Specifically, the vehicle speed sensor 407 converts a detected number of revolutions of a wheel into pulse signals, and outputs predetermined information such as the number of pulse signals within predetermined time. The gyro sensor 408 is formed of an optical fiber gyro, a vibration gyro, and the like, and detects an angular speed by rotation of a movable body. The GPS information reception device 409 receives signals from GPS satellites, and measures a current location, a traveling speed, and a traveling azimuth of the vehicle by measuring a distance between the vehicle and each GPS satellite and a change rate in each distance with respect to a predetermined number of (for example, four) satellites.

The VICS information reception device 410 is a device that receives road traffic information (VICS information) related to a traffic jam, an accident, or road construction. The communication device 411 is a communication module that performs information communication with an external device (for example, the guide information generation device 100).

The hardware configuration of each of the guide information generation device 100 and the guide output device 200 is described above.

Note that the arithmetic unit 110 of the guide information generation device 100 is achieved by programs causing the CPU of the arithmetic device 301 to perform processing. The programs are stored in, for example, the main storage device 302 or the auxiliary storage device 303, and are loaded on the RAM for execution and executed by the CPU. The storage unit 120 may be implemented by the main storage device 302 or the auxiliary storage device 303, or may be implemented by a combination of the main storage device 302 and the auxiliary storage device 303. The communication unit 130 is implemented by the communication device 304.

The arithmetic unit 210 of the guide output device 200 is implemented by programs causing the CPU 401a of the arithmetic device 401 to perform processing. The programs are stored in, for example, the storage device 403 or the ROM 401c, and are loaded on the RAM 401b for execution and executed by the CPU 401a. The storage unit 220 may be implemented by the RAM 401b, the ROM 401c, or the storage device 403, or may be achieved by a combination of the RAM 401b, the ROM 401c, and the storage device 403. The communication unit 230 may be implemented by the VICS information reception device 410 or the communication device 411, or may be implemented by a combination of the VICS information reception device 410 and the communication device 411.

Each functional block of the guide information generation device 100 and the guide output device 200 is classified according to a main processing content in order to facilitate understanding of each function achieved in the present embodiment. Therefore, how each function is classified and referred to do not limit the present invention. The configuration of each of the guide information generation device 100 and the guide output device 200 can be further classified to have more components according to a processing content. The configuration can be classified such that one component performs more processing.

The whole or a part of each function unit may be constituted with hardware (an integrated circuit such as an ASIC, and the like) mounted on a computer. Further, processing of each function unit may be performed by one piece of hardware, or may be performed by a plurality of pieces of hardware.

[Description of Operation]

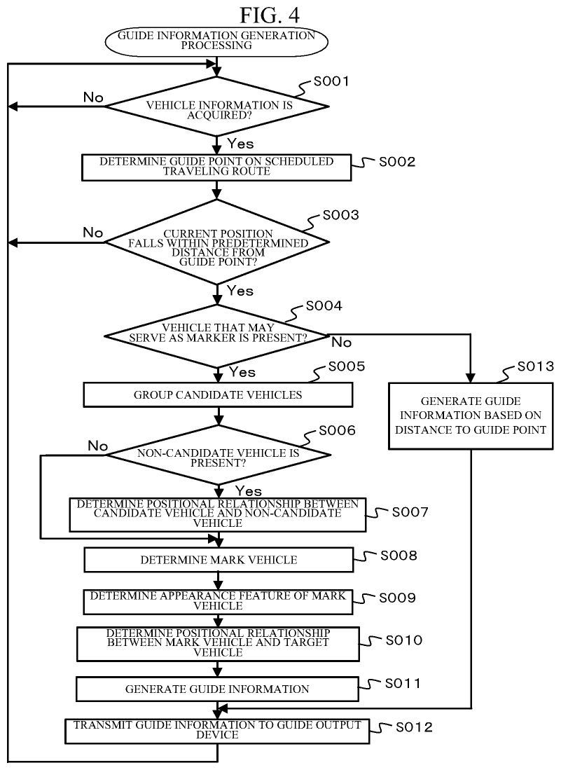

FIG. 4 is a flowchart illustrating an example of guide information generation processing performed by the guide information generation device 100. The processing starts together with activation of the guide information generation device 100, for example.

When the processing starts, the guide point determination unit 111 determines whether or not the vehicle information 122 is acquired (Step S001). Specifically, the guide point determination unit 111 determines whether or not the vehicle information 122 transmitted from the guide output device 200 periodically (for example, every second) is acquired via the communication unit 130. Then, when the guide point determination unit 111 determines that the vehicle information 122 is not acquired (No in Step S001), the guide point determination unit 111 performs the processing in Step S001 again. On the other hand, when the guide point determination unit 111 determines that the vehicle information 122 is acquired (Yes in Step S001), the guide point determination unit 111 proceeds the processing to Step S002.

In Step S002, the guide point determination unit 111 determines a guide point on a scheduled traveling route, based on route information included in the vehicle information 122. Specifically, the guide point determination unit 111 determines the scheduled traveling route from the route information included in the vehicle information 122. By using the scheduled traveling route and the map information 121 in the storage unit 120, the guide point determination unit 111 determines, as the guide point, a branch point such as an intersection where a transmission source vehicle of the vehicle information 122 makes a right turn or a left turn. By using the map information 121 and the scheduled traveling route, the guide point determination unit 111 determines a direction (either a right turn or a left turn) in which the vehicle makes a turn at the guide point.

Next, the mark vehicle determination unit 112 determines whether or not a current position of the vehicle falls within a predetermined distance (for example, within 1 km, within 500 m, or the like) from a nearest guide point located ahead in a traveling direction (Step S003). Specifically, the mark vehicle determination unit 112 determines the current position of the vehicle, based on positional information included in the vehicle information 122. The mark vehicle determination unit 112 determines the traveling direction of the vehicle from the scheduled traveling route. The mark vehicle determination unit 112 determines whether or not the current position of the vehicle falls within the predetermined distance from the nearest guide point located ahead in the traveling direction, based on the guide point determined by the guide point determination unit 111, the current position of the vehicle, and the traveling direction of the vehicle.

Then, when the mark vehicle determination unit 112 determines that the current position does not fall within the predetermined distance (No in Step S003), the mark vehicle determination unit 112 returns the processing to Step S001. On the other hand, when the mark vehicle determination unit 112 determines that the current position falls within the predetermined distance (Yes in Step S003), the mark vehicle determination unit 112 proceeds the processing to Step S004.

Note that the mark vehicle determination unit 112 identifies, as a target vehicle, the vehicle at the current position determined to fall within the predetermined distance from the nearest guide point located ahead in the traveling direction, and performs the following processing.

In Step S004, the mark vehicle determination unit 112 determines whether or not a vehicle that may serve as a marker at the guide point is present around the target vehicle. Specifically, when there is a vehicle traveling ahead within a predetermined distance (for example, within 100 m or within 50 m) from the target vehicle and that makes a turn in the same direction as that of the target vehicle at the nearest guide point, the mark vehicle determination unit 112 determines that a vehicle that may serve as a marker is present.

More specifically, the mark vehicle determination unit 112 acquires, from the storage unit 120, the vehicle information 122 acquired from a vehicle other than the target vehicle, and determines a vehicle traveling ahead within the predetermined distance from the target vehicle, based on positional information included in the vehicle information 122. When there is the determined vehicle, the mark vehicle determination unit 112 determines a scheduled traveling route of the vehicle from route information included in the vehicle information 122. The guide point determination unit 111 determines, by using the scheduled traveling route and the map information 121, the guide points of the determined vehicle and a turning direction at each guide point.

Then, when a nearest guide point and the turning direction of the determined vehicle coincide with the nearest guide point and the turning direction of the target vehicle, the mark vehicle determination unit 112 determines that a vehicle that may serve as the marker of a right/left turn is present around the target vehicle (Yes in Step S004). In this case, the mark vehicle determination unit 112 proceeds the processing to Step S005. On the other hand, when the mark vehicle determination unit 112 determines that the vehicle that may serve as a marker is not present (No in Step S004), the mark vehicle determination unit 112 proceeds the processing to Step S013.

Note that, in Step S013, the guide generation unit 113 generates the guide information based on a distance of the target vehicle to the nearest guide point. Specifically, the guide generation unit 113 calculates the distance of the target vehicle to the nearest guide point by using the positional information about the target vehicle and the map information 121, and generates guide information including sound information such as “turn right at the intersection 100 m ahead” or “turn left at the branch point 120 m ahead”, for example. When the guide generation unit 113 generates guide information, the guide generation unit 113 proceeds the processing to Step S012.

In Step S005 to which processing proceeds when the mark vehicle determination unit 112 determines that the vehicle that may serve as the marker of a right/left turn is present (Yes in Step S004), the mark vehicle determination unit 112 groups (forms a group), as one or more candidate vehicles, the one or more vehicles that may serve as the marker. Specifically, the mark vehicle determination unit 112 groups, as the candidate vehicles being the marker, a vehicle (the vehicle determined in Step S004) in which the nearest guide point and the turning direction coincide with the nearest guide point and the turning direction of the target vehicle.

Next, the mark vehicle determination unit 112 determines whether or not a non-candidate vehicle is present (Step S006). Note that the non-candidate vehicle is a vehicle that is traveling around the target vehicle, i.e., ahead within a predetermined distance (for example, within 100 m or within 50 m) from the target vehicle, and that does not make a turn at the nearest guide point of the target vehicle or makes a turn in a direction different from the turning direction of the target vehicle at the nearest guide point of the target vehicle.

The mark vehicle determination unit 112 determines presence or absence of the non-candidate vehicle by processing similar to Step S004. Specifically, the mark vehicle determination unit 112 determines, by using the vehicle information 122 acquired from a vehicle other than the target vehicle, a vehicle traveling ahead within a predetermined distance from the target vehicle. When there is the determined vehicle, the mark vehicle determination unit 112 determines, by using the scheduled traveling route of the vehicle and the map information 121, the guide points of the determined vehicle and a turning direction at each guide point. Then, when a nearest guide point and the turning direction of the determined vehicle do not coincide with the nearest guide point and the turning direction of the target vehicle, the mark vehicle determination unit 112 determines that the non-candidate vehicle is present.

Then, when the mark vehicle determination unit 112 determines that the non-candidate vehicle is not present (No in Step S006), the mark vehicle determination unit 112 proceeds the processing to Step S008. On the other hand, when the mark vehicle determination unit 112 determines that the non-candidate vehicle is present (Yes in Step S006), the mark vehicle determination unit 112 proceeds the processing to Step S007.

In Step S007, the mark vehicle determination unit 112 determines a positional relationship among the target vehicle, the one or more candidate vehicles, and the non-candidate vehicle. Specifically, the mark vehicle determination unit 112 determines the positional relationship by comparing current positions of the vehicles, based on positional information about each of the vehicles.

Next, the mark vehicle determination unit 112 determines a mark vehicle according to a predetermined rule (Step S008). Specifically, when the candidate vehicle is only one, the mark vehicle determination unit 112 determines the candidate vehicle as the mark vehicle. When there is a plurality of candidate vehicles, the mark vehicle determination unit 112 determines, as the mark vehicle, a candidate vehicle (hereinafter may be referred to as a “first candidate vehicle”) traveling in a position closest to the target vehicle among the candidate vehicles. When the non-candidate vehicle is located between the target vehicle and the first candidate vehicle, and one or more candidate vehicles (hereinafter may be referred to as a “second candidate vehicle(s)”) traveling in a lane different from a traveling lane of the target vehicle are present, the mark vehicle determination unit 112 determines, as the mark vehicle, a vehicle traveling in a position closest to the target vehicle in the one or more second candidate vehicles. Note that, when the non-candidate vehicle is located between the target vehicle and the first candidate vehicle, and no second candidate vehicle is present, the mark vehicle determination unit 112 determines the first candidate vehicle as the mark vehicle.

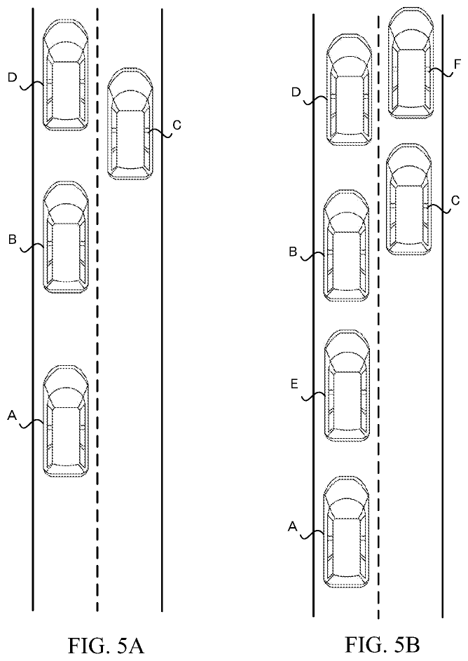

FIGS. 5A and 5B are each a diagram illustrating positional relationship among the target vehicle, the candidate vehicles, and the non-candidate vehicle. As illustrated in FIG. 5A, when a non-candidate vehicle is not sandwiched between a target vehicle A and candidate vehicles B, C, and D, a first candidate vehicle is the candidate vehicle B traveling in a position closer to the target vehicle A, and the candidate vehicle B is determined as the mark vehicle. As illustrated in FIG. 5B, when a non-candidate vehicle E is located between the target vehicle A and the first candidate vehicle B, it may be difficult for a driver to visually recognize the first candidate vehicle B. Thus, in the rule, when one or more vehicles traveling in a lane different from that of the target vehicle A are present, the one or more vehicles (vehicles C and F) are set as second candidate vehicles, and the vehicle C traveling in a position closest to the target vehicle A among the second candidate vehicles is determined as the mark vehicle.

Such a predetermined rule is set for a purpose of setting, as a mark vehicle, a candidate vehicle that is more easily found (more easily identified) by the driver of the target vehicle among candidate vehicles. Thus, the predetermined rule is not limited to the content described above, and the mark vehicle determination unit 112 may preferentially determine, as the mark vehicle, a candidate vehicle having a conspicuous body color (for example, red, yellow, blue, fluorescent color, and the like) among the candidate vehicles, for example. The mark vehicle determination unit 112 may preferentially determine, as the mark vehicle, a candidate vehicle (for example, a truck, an SUV, and the like) having a larger body shape.

Next, the mark vehicle determination unit 112 determines an appearance feature of the mark vehicle (Step S009). Specifically, the mark vehicle determination unit 112 determines the appearance feature of the mark vehicle, based on the appearance information included in the vehicle information 122 about the mark vehicle.

Next, the mark vehicle determination unit 112 determines a positional relationship between the mark vehicle and the target vehicle (Step S010). Specifically, the mark vehicle determination unit 112 determines which position the mark vehicle travels in front of the target vehicle, based on a distance between the target vehicle and the mark vehicle, and lanes in which the target vehicle and the mark vehicle travel.

Next, the guide generation unit 113 generates guide information (Step S011). Specifically, the guide generation unit 113 generates the guide information that includes the appearance feature for identifying the mark vehicle determined in Step S009, and the positional relationship between the target vehicle and the mark vehicle, and that guides a turn at the nearest guide point with the mark vehicle as the marker. Note that, when the target vehicle and the mark vehicle travel in different lanes, a positional relationship between the target vehicle and the mark vehicle includes information indicating a side (a right side or a left side) on which a lane in which the mark vehicle travels is located with reference to a lane in which the target vehicle travels.

More specifically, the guide generation unit 113 generates the guide information including sound information such as “turn right ahead in the same direction at the intersection where the red sedan traveling about 10 m ahead turns” or “turn left ahead in the same direction at the intersection where the truck traveling about 20 m ahead in the left lane turns”, for example.

Next, the guide generation unit 113 transmits the generated guide information to the guide output device 200 via the communication unit 130 (Step S012), and terminates the processing of the flow.

Note that, when the guide unit 215 of the guide output device 200 acquires the guide information via the communication unit 230, the guide unit 215 provides the guide at a guide point by using the guide information. Specifically, the guide unit 215 acquires the sound information included in the guide information, and provides a guide by outputting the sound information to the speaker 404b.

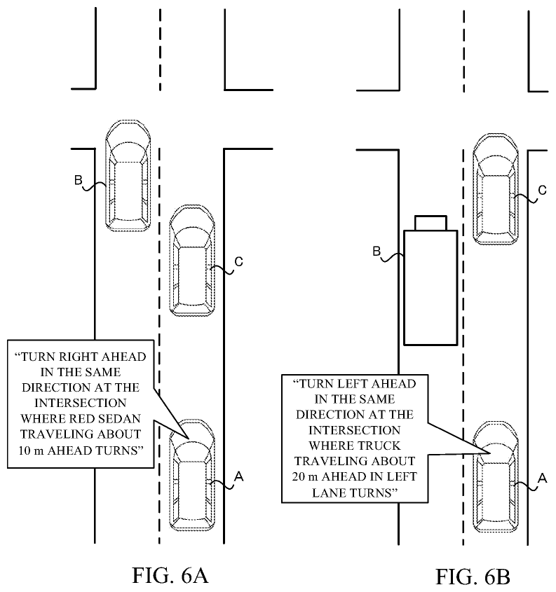

FIGS. 6A and 6B are each a diagram illustrating a scene where a guide is provided. FIG. 6A illustrates a scene where a mark vehicle C (for example, car type: regular passenger car, body color: red, type of body shape: sedan) travels 10 m ahead of the target vehicle A. In this case, the guide unit 215 outputs sound information such as “turn right ahead in the same direction at the intersection where the red sedan traveling about 10 m ahead turns”, based on the guide information. FIG. 6B illustrates a scene where the mark vehicle B (for example, car type: large-sized special vehicle, body color: white, type of body shape: truck) travels 20 m ahead in a lane different from that of the target vehicle A. In this case, the guide unit 215 outputs sound information such as “turn left ahead in the same direction at the intersection where the truck traveling about 20 m ahead in the left lane turns”, based on the guide information.

The guide system according to the present embodiment is described above. Such a guide system can indicate a marker that is more intuitively clear to guide a user. Particularly, the guide information generation device provides a guide at the guide point with, as a mark vehicle, a vehicle that is traveling around the target vehicle and is scheduled to turn in the same direction at the same guide point. Thus, a user (driver) can recognize the guide point such as an intersection where a right/left turn is made and a turning direction with, as a marker, the vehicle actually traveling ahead, and thus the user can more intuitively recognize a position of the guide point and the turning direction at the guide point. Therefore, the present guide system can provide a clearer guide than a method (conventional method) for providing a guide, based on a distance to the guide point, for example.

Note that the present invention is not limited to such embodiments, and various modification examples are possible. For example, when a distance to a mark vehicle is short, the guide generation unit 113 according to a first modification example may include a license plate number of the mark vehicle in guide information. Specifically, when a distance to the mark vehicle falls within a predetermined distance (for example, within 10 m), the guide generation unit 113 acquires the license plate number from the vehicle information 122 about the mark vehicle, and includes the number in the guide information such that the number is output as sound information. More specifically, the guide generation unit 113 generates the guide information including the sound information such as “turn right ahead in the same direction at the intersection where the red sedan traveling about 10 m ahead turns. Number of red sedan is ***.”, for example.

According to such guide information, a driver of a target vehicle can more reliably identify the mark vehicle. Particularly, when the mark vehicle and the target vehicle are located in extremely close positions, the driver of the target vehicle can confirm the license plate number of the mark vehicle, and thus useful information for identifying the mark vehicle can be provided by including the number in the guide information.

The guide generation unit 113 according to a second modification example may include, in guide information, information indicating how many vehicles a mark vehicle is ahead of, based on a distance to the mark vehicle. Specifically, the guide generation unit 113 calculates the distance between a target vehicle and the mark vehicle, based on positional information about the target vehicle and the mark vehicle. The guide generation unit 113 calculates how many vehicles the distance to the mark vehicle corresponds to by multiplying the calculated distance by a value acquired by adding a predetermined distance between vehicles to a predetermined length (for example, a general total length of a vehicle of 48600 mm).

The guide generation unit 113 generates the guide information in which the distance to the mark vehicle is replaced with an approximate number of vehicles. Specifically, the guide generation unit 113 generates the guide information including sound information such as “turn right ahead in the same direction at the intersection where the red sedan traveling ahead by approximately two vehicles turns”, for example.

According to such guide information, the distance to the mark vehicle that is difficult to intuitively recognize is replaced with the number of vehicles and is guided, and thus it is easier for the driver to grasp an estimated position in which the mark vehicle is traveling. As a result, the driver of the target vehicle can more easily find (identify) the mark vehicle.

In a third modification example, the guide generation unit 113 includes, in guide information, image information indicating an appearance feature about a mark vehicle and a turning direction at a guide point. Specifically, the guide generation unit 113 determines a car type, a body color, and a type of a body shape that are the appearance feature of a vehicle, based on appearance information included in the vehicle information 122 about the mark vehicle. The guide generation unit 113 generates image information indicating an image (for example, an image of the vehicle having the body shape and the body color of the mark vehicle) representing the appearance feature of the determined mark vehicle and the turning direction at the guide point, and generates guide information including the image information. Note that a plurality of image patterns acquired by combining various car types, body colors, and types of body shapes may be previously stored in the storage unit 120. The guide information generation device 100 may generate guide information including both of the sound information described above and the image information, or may generate guide information that includes the image information and does not include the sound information described above.

The guide unit 215 of the guide output device 200 that acquires the guide information displays, on the display device 402, the image information included in the guide information.

According to such guide information, the driver (user) can more easily find the mark vehicle from vehicles traveling around by confirming an image of the vehicle representing the appearance feature of the mark vehicle.

In the embodiments described above, the guide information generation device 100 generates guide information and transmits the guide information to the guide output device 200, but the present invention is not limited to such embodiments. In a fourth modification example, the guide output device 200 acquires, from the guide information generation device 100, predetermined information needed to generate guide information, and generates the guide information by using the predetermined information.

Specifically, the guide unit 215 acquires, from the guide information generation device 100, information indicating an appearance feature of a mark vehicle and information indicating a positional relationship between a target vehicle being an own vehicle and the mark vehicle via the communication unit 230, and generates guide information by using these pieces of information. More specifically, by using the information acquired from the guide information generation device 100, the guide unit 215 generates, by a method similar to that in the embodiments described above or the third modification example, guide information that includes an appearance feature for identifying the mark vehicle and a positional relationship between the target vehicle and the mark vehicle, and includes sound information or image information for guiding a turn at a nearest guide point with the mark vehicle as a marker.

The guide system including such a guide output device can also indicate a marker that is more intuitively clear to guide the user. Particularly, a processing load on the guide information generation device can be reduced by the guide output device taking care of a part of processing, and the guide output device can acquire guide information from the guide information generation device at an early timing. As a result, the guide output device can output guide information for identifying the mark vehicle with room for distance and time to the guide point.

The guide output device 200 may be implemented by application software (hereinafter may be referred to as an “app”) installed in a smartphone and a tablet terminal (hereinafter may be referred to as a “user terminal device”). In this case, the app receives an input of a departure place and a destination from a user, and calculates a recommended route. The app receives, from a user, registration of information related to an appearance feature of a vehicle, and stores the information in a storage region in the user terminal device. The app determines a current position of the vehicle on a map by using map information being previously stored in the storage region in the user terminal device and a current position of the vehicle acquired via a reception unit of GPS information built in the user terminal device. The app generates the vehicle information 122 including these pieces of information, and periodically transmits the vehicle information 122 to the guide information generation device 100.

When the app acquires guide information from the guide information generation device 100, the app outputs sound information, image information, or both of the sound information and the image information that are included in the guide information to a display and a speaker included in the user terminal device.

When such a user terminal device is used as the guide output device, processing similar to that in the embodiments and the modification examples described above can also be performed, and a similar effect can be acquired.

The present invention is not limited to the embodiments and the modification examples described above, and the like, and various embodiments and modification examples other than those described above are included. For example, the embodiments described above are described in detail for the sake of better understanding of the present invention, and the present invention is not necessarily limited to including all the described configurations. A part of a configuration of one embodiment can be replaced with a configuration of another embodiment or another modification example, and a configuration of another embodiment can also be added to a configuration of one embodiment. Another configuration can be added to, deleted from, and replaced with a part of a configuration of each embodiment.

1. A guide generation method performed by a computer, the guide generation method comprising:
a vehicle information acquisition step of acquiring, by the computer, vehicle information including a current position and an appearance feature of a vehicle;
a guide point determination step of determining, by the computer, a guide point located on a scheduled traveling route of the vehicle, based on the vehicle information and map information;
a mark vehicle determination step of determining, by the computer, a mark vehicle, among vehicles traveling around a target vehicle, from one or more candidate vehicles that make a turn at the same guide point in the same direction as the guide point and a direction of the target vehicle; and
a guide information generation step of generating, by the computer, guide information that includes the appearance feature of the mark vehicle and a positional relationship between the target vehicle and the mark vehicle, and that guides a turn at the guide point with the mark vehicle as a marker.

2. The guide generation method according to claim 1, wherein
in the mark vehicle determination step,
when a non-candidate vehicle other than the target vehicle and the one or more candidate vehicles is located between the target vehicle and the one or more candidate vehicles, the mark vehicle is determined from one or more candidate vehicles traveling in a lane different from a lane of the target vehicle.

3. The guide generation method according to claim 1, wherein
in the mark vehicle determination step,
when a non-candidate vehicle other than the target vehicle and the one or more candidate vehicles is located between the target vehicle and the one or more candidate vehicles, the mark vehicle is determined from the one or more candidate vehicles that are of a predetermined body color or a predetermined type of a body shape.

4. The guide generation method according to claim 1, wherein
in the guide information generation step,
the guide information for providing the guide is generated by including a license plate number of the mark vehicle when the target vehicle and the mark vehicle are located within a predetermined distance.

5. The guide generation method according to claim 1, wherein
in the guide information generation step,
how many vehicles ahead of the target vehicle the mark vehicle corresponds to is calculated, based on a distance between the target vehicle and the mark vehicle, and the guide information for providing the guide is generated by including the calculated number of vehicles.

6. The guide generation method according to claim 1, wherein
in the guide information generation step,
the guide information is generated, the guide information including sound information for providing the guide, or the sound information and image information about a vehicle that represents an appearance feature of the mark vehicle.

7. The guide generation method according to claim 1, further comprising:
by the computer,
a step of transmitting the guide information to an external device mounted on the target vehicle;
by the external device,
a step of transmitting the vehicle information; and
a guide step of providing a guide of the target vehicle by using the guide information.

8. A guide generation system comprising a guide information generation device and a guide output device, wherein
the guide information generation device includes
a guide point determination unit configured to acquire, from the guide output device, vehicle information including a current position and an appearance feature of a vehicle, and determine a guide point located on a scheduled traveling route of the vehicle, based on the vehicle information and map information,
a mark vehicle determination unit configured to determine a mark vehicle, among vehicles traveling around a target vehicle, from candidate vehicles that make a turn at the same guide point in the same direction as the guide point and a direction of the target vehicle, and
a guide information generation unit configured to generate guide information that includes the appearance feature of the mark vehicle and a positional relationship between the target vehicle and the mark vehicle, and that guides a turn at the guide point with the mark vehicle as a marker, and
the guide output device includes
a vehicle information generation unit configured to generate the vehicle information,
a communication unit configured to transmit the vehicle information to the guide information generation device, and
a guide unit configured to provide a guide of the target vehicle by using the guide information acquired from the guide information generation device.
